(19) United States
(12) Patent Application Publication
(10) Pub. No.: US 2004/0095325 A1
(43) Pub. Date: May 20, 2004

(54) Computer keyboard

(76) Inventor: Hui-Hu Liang, Chang Hua (TW)

Correspondence Address: Hui-Hu Liang, 235 Chung-Ho, Box 8-24, Taipei, TW

(21) Appl. No.: 10/295,049

(22) Filed: Nov. 15, 2002

(51) Int. Cl. G09G 5/00

(52) U.S. Cl. 345/168

(57) ABSTRACT

A computer keyboard has a receiving space. A lateral side of the receiving space is installed with an inserting seat for being inserted by a charging seat. A lateral side of the charging seat is exactly inserted by a plug at an interior of the receptacle of the keyboard. A top of the charging seat has a transmission slot for installing a mobile phone. The specification of the transmission slot is designed based on the specification of the mobile phone to be inserted. The charging seat is made as a plug-in structure. The plug of the charging seat is made according to the specification of the charging seat of a mobile phone. Thereby, the mobile phone can be charged by the receptacle of the keyboard and thereby, a multi-functional keyboard is formed.

### FIELD OF THE INVENTION

The present invention relates to computer keyboards, and particularly to a multi-functional computer keyboard which has a receiving space for being installed with an inserting seat so as to be installed with other means and thus the function of the keyboard is expanded.

In the prior art, the computer keyboard has only one function of inputting data. However, the keyboard often occupies a finite space in the table. If the keyboard can integrate with other functions, such as charging, data transmission, etc. Then the space in the working table is used effectively. Moreover, the cost is saved.

### SUMMARY OF THE INVENTION

Accordingly the primary object of the present invention is to provide a computer keyboard. A receiving space is formed at a predetermined position of the keyboard. A lateral side of the receiving space is installed with an inserting seat for being inserted by a charging seat. In a lateral side of the charging seat is exactly inserted by a plug at an interior of the receptacle of the keyboard. A top of the charging seat has a transmission slot for installing a mobile phone. The specification of the transmission slot is designed based on the specification of the mobile phone to be inserted. The charging seat is made as a plug-in structure. The plug of the charging seat is made according to the specification of the charging seat of a mobile phone. Thereby, the mobile phone can be charged by the receptacle of the keyboard and thereby, a multi-functional keyboard is formed.

Another object of the present invention is to provide a computer keyboard, wherein after the charging seat is inserted into the receptacle of the keyboard, a lateral side of the charging seat resists against an inner lateral side of the rotary cover or fixing the body the mobile phone. A transmission device of a PDA is inserted to the receptacle of the keyboard for connecting the PDA with a computer so that signals are transferred bi-directionally.

The various objects and advantages of the present invention will be more readily understood from the following detailed description when read in conjunction with the appended drawing.

### BRIEF DESCRIPTION OF THE DRAWINGS

FIG. 1 is an exploded perspective view of the present invention.

FIG. 2 is an assembled perspective view of the present invention.

FIG. 3 shows one embodiment about the use of opening a rotary cover in the present invention.

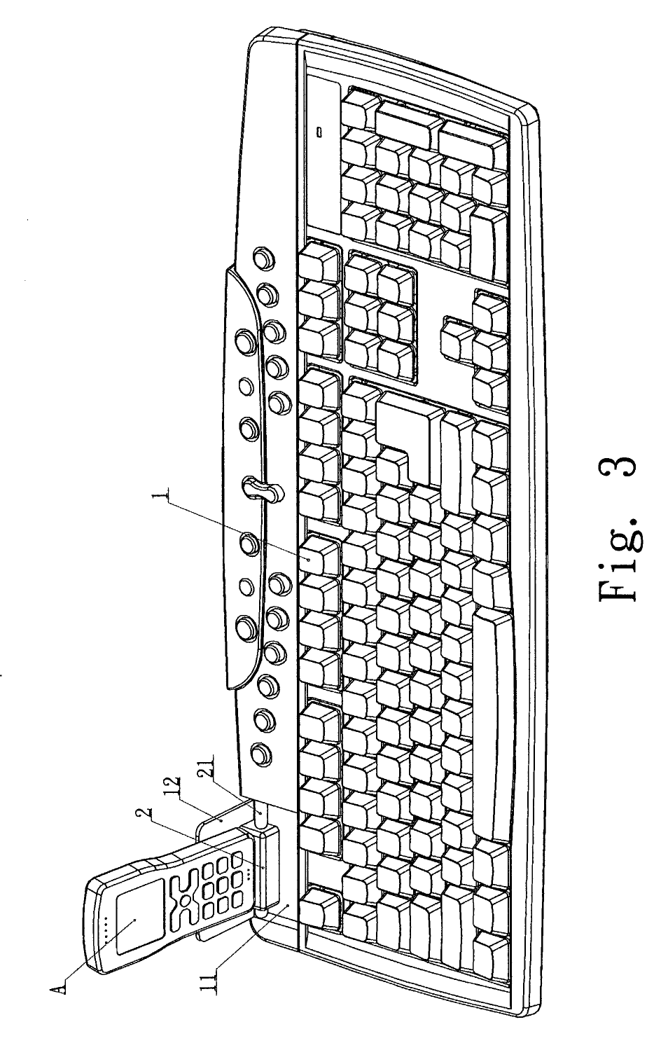

FIG. 4 shows one embodiment about the use of closing a rotary cover according to the present invention.

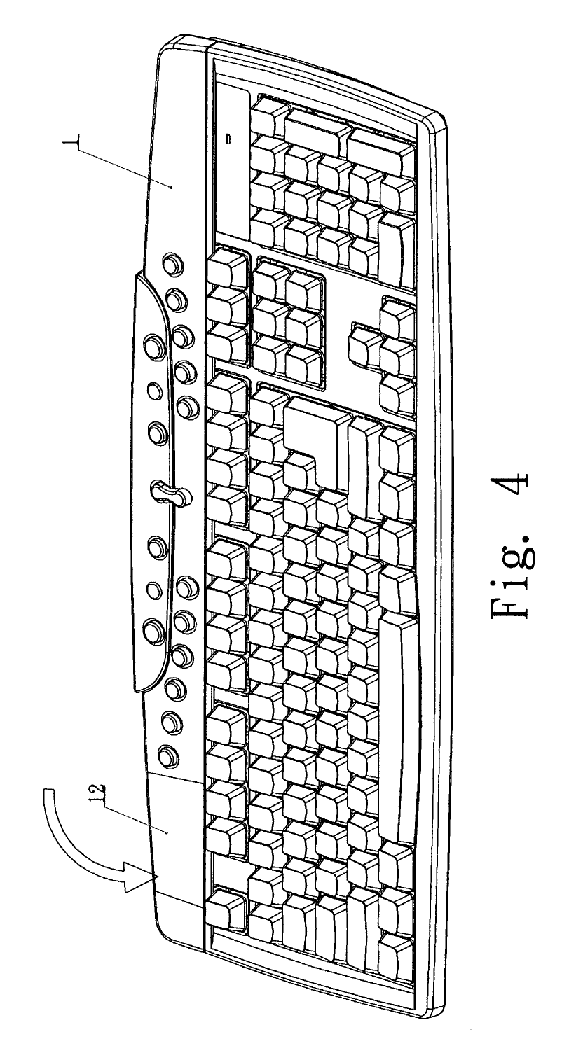

### DETAILED DESCRIPTION OF THE PREFERRED EMBODIMENTS

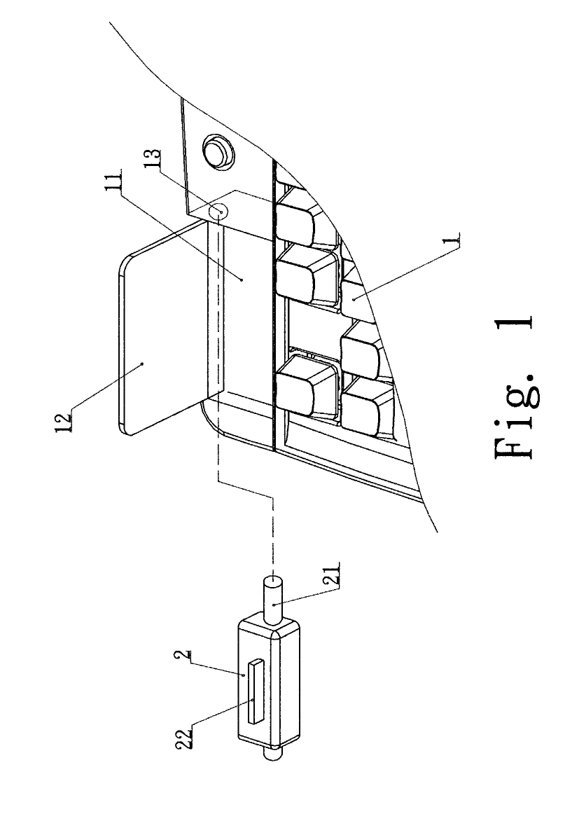

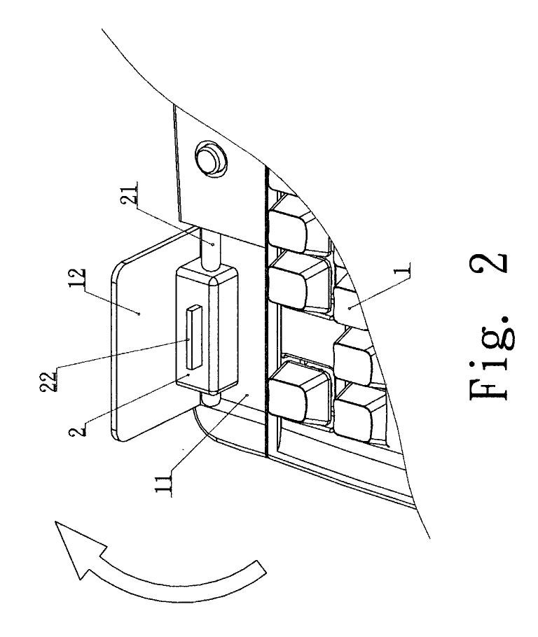

With reference to FIGS. 1 and 2, the structure of the present invention is clearly shown. In the present invention, the computer keyboard 1 of the present invention has a receiving space 11 at a predetermined portion thereof. A rotary cover 12 covers the receiving space 11. After the rotary cover 12 covers thereon. The edge of the rotary cover 12 is flushed with the surface of the keyboard 1. A lateral side of the receiving space 11 is installed with an inserting seat 13 for being inserted by a charging seat 2 (or the transmission device of a PDA (Personal Digital Assistant)).

A lateral side of the charging seat 2 is exactly inserted by a plug 21 at the interior of the receptacle 13 of the keyboard 1. A top of the charging seat 2 has a transmission slot 22 for installing a mobile phone A. The specification of the transmission slot 22 is designed based on the specification of the mobile phone A to be inserted. The charging seat 2 is made as a plug-in structure. The plug 21 of the charging seat 2 is made according to the specification of the charging seat of a mobile phone. Thereby, the mobile phone can be charged by the receptacle 13 of the keyboard 1. After the charging seat 2 is inserted into the receptacle 13 of the keyboard 1, a lateral side of the charging seat 2 resists against an inner lateral side of the rotary cover 12 for fixing the body the mobile phone.

A transmission device of a PDA can be inserted to the receptacle 13 of the keyboard 1 for connecting the PDA with a computer so that signals can be transferred bi-directionally. Thus, a multi-functional computer is achieved.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

1. A computer keyboard; a receiving space being formed at a predetermined position of the keyboard; a lateral side of the receiving space being installed with an inserting seat for being inserted by a charging seat;
wherein a lateral side of the charging seat being exactly inserted by a plug at an interior of the receptacle of the keyboard; a top of the charging seat has a transmission slot for installing a mobile phone; the specification of the transmission slot is designed based on the specification of the mobile phone to be inserted; the charging seat is made as an plug-in structure; the plug of the charging seat is made according to the specification of the charging seat of a mobile phone; thereby, the mobile phone can be charged by the receptacle of the keyboard; and
thereby, a multi-functional keyboard is formed.

2. The computer keyboard as claim in claim 1, wherein a rotary cover covers the receiving space; after the rotary cover covers thereon; and an edge of the rotary cover is flushed with the surface of the keyboard.

3. The computer keyboard as claim in claim 1, wherein after the charging seat is inserted into the receptacle of the keyboard, a lateral side of the charging seat resists against an inner lateral side of the rotary cover or fixing the mobile phone.

4. The computer keyboard as claim in claim 1, wherein a transmission device of a PDA is inserted to the receptacle of the keyboard for connecting the PDA with a computer so that signals are transferred bi-directionally.
